(19) United States
(12) Patent Application Publication
(10) Pub. No.: US 2011/0112824 A1
(43) Pub. Date: May 12, 2011

(54) DETERMINING AT LEAST ONE CATEGORY PATH FOR IDENTIFYING INPUT TEXT

(76) Inventors: Craig Peter Sayers, Menlo Park, CA (US); Ignacio Zendejas, Los Angeles, CA (US); Rajan Lukose, Oakland, CA (US); Martin Scholz, San Francisco, CA (US); Shyamsundar Rajaram, San Francisco, CA (US)

(21) Appl. No.: 12/614,260

(22) Filed: Nov. 6, 2009

(51) Int. Cl. G06F 17/27

(52) U.S. Cl. 704/9

(57) ABSTRACT

In a method of determining at least one category path for identifying an input text, one or more categories that are most relevant to the input text are determined, one or more concepts that are most relevant to the input text using information from a labeled text data source and the one or more categories determined to be the most relevant to the input text are determined, and one or more category paths through a hierarchy of predefined category levels are determined for one or more of the determined concepts.

### CROSS-REFERENCE TO RELATED APPLICATION

The present application shares some common subject matter with co-pending and commonly assigned U.S. patent application Ser. No. TBD (Attorney Docket No. 200902302-1), entitled “Visually Representing a Hierarchy of Category Nodes”, filed on even date herewith, the disclosure of which is hereby incorporated by reference in its entirety.

### BACKGROUND

A user's web browsing history is a rich data source representing a user's implicit and explicit interests and intentions, and of completed, recurring, and ongoing tasks of varying complexity and abstraction, and is thus a valuable resource. As the web continues to become ever more essential and the key tool for information seeking and retrieval, various web browsing mechanisms that organize a user's web browsing history have been introduced. These web browsing mechanisms range from mechanisms that organize a user's web browsing history using a simple chronological list to mechanisms that organize a user's web browsing history through visitation features, such as, uniform resource locator (URL) domain and visit count.

### BRIEF DESCRIPTION OF THE DRAWINGS

Features of the present invention will become apparent to those skilled in the art from the following description with reference to the figures, in which:

FIG. 1 shows a simplified block diagram of a system for determining category paths for identifying an input text, according to an example embodiment of the invention;

FIG. 2A illustrates a flow diagram of a method of determining at least one category path for identifying an input text, according to an example embodiment of the invention;

FIG. 2B illustrates a more detailed flow diagram of the method of determining at least one category path for identifying an input text depicted in FIG. 2A, according to an example embodiment of the invention; and

FIG. 3 shows a block diagram of a computing apparatus configured to be implemented as a platform for executing one or more of the functions described herein with respect to the system depicted in FIG. 1 and the method depicted in FIGS. 2A and 2B, according to an example embodiment of the invention.

### DETAILED DESCRIPTION

For simplicity and illustrative purposes, the present invention is described by referring mainly to an example embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and apparatus for automatically assigning an input text with a machine-readable label from a labeled text data source. The labeled text data source generally comprises a publicly available source of ontology information in which various concepts are assigned to one or more categories. Examples of suitable labeled text data sources include, Wikipedia™, Freebase™, IMDB™, and the like. In addition, the method and apparatus of the present invention are also configured to automatically determine one or more category paths through a hierarchy of predefined category levels that identify the input text.

According to an embodiment, the one or more category paths that identify the input text may be employed by a computer application to one or more of organize, store, and display the input text as well as other content that is determined to be related to the input text. Thus, for instance, the input text may be located through a search for the context or concept associated with the input text instead of having to search for individual identifying information of the input text, such as the title or matching text. In one respect, therefore, the amount of time and manual labor required to categorize a plurality of input text for storage and future retrieval may substantially be reduced through implementation of the method and apparatus disclosed herein.

Furthermore, through implementation of the method and apparatus disclosed herein, the one or more category paths generated to identify the input text may be used to identify a hierarchical representation of a concept associated with the input text rather than just the concept. In one regard, traversing the hierarchy of category levels that identify the input text enables a progressively more refined identification of one or more concepts associated with the input text. Thus, a user may access one or more the categories in the various category levels of the hierarchy to identify, for instance, other text or documents that are relevant to those various category levels and not just to the input text. In addition, implementation of the method disclosed herein, by exploiting the hierarchical structure inherent within the labeled text data sources (e.g., Wikipedia™), may significantly reduce the burden of manual taxonomy construction that would be required in less sophisticated methods.

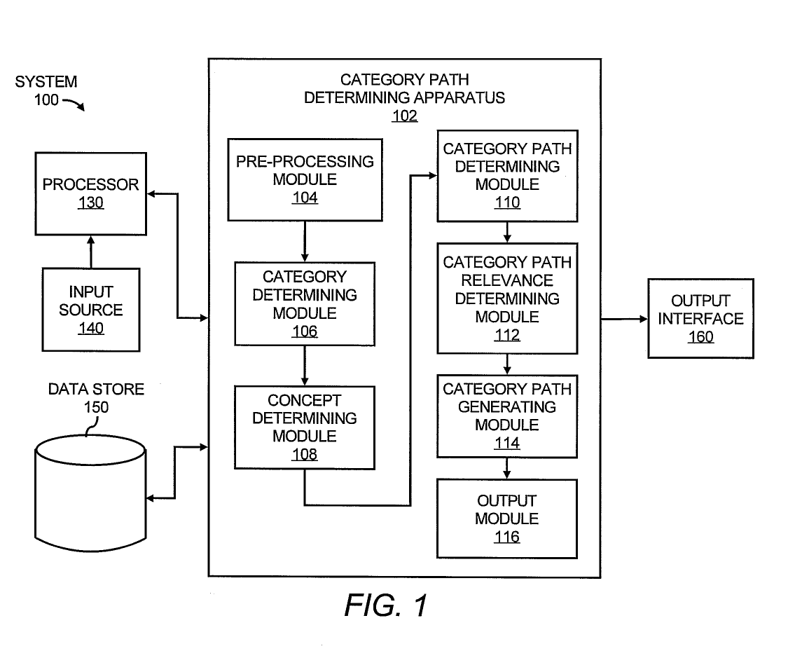

With reference first to FIG. 1, there is shown a simplified block diagram of a system 100 for determining category paths for identifying an input text, according to an example. It should be understood that the system 100 may include additional components and that some of the components described herein may be removed and/or modified without departing from the scope of the system 100. For instance, the system 100 may include any number of additional applications or software configured to perform any number of other functions discussed with respect to the system 100. In addition, it should be understood that the input text may be contained in any type of document, both physical and a hyper text markup language formatted stored on a computer memory, such as, a webpage (i.e., an extensible markup language (XML) formatted, etc., document), a magazine article, an email message, a text message, a newspaper article, a handwritten note, an entry in a database, etc. Moreover, the system 100 may be applied to some or all of the text contained in a selected document.

The system 100 comprises a computing device, such as, a personal computer, a laptop computer, a tablet computer, a personal digital assistant, a cellular telephone, etc., configured with a category path determining apparatus 102, a processor 130, an input source 140, a message store 150, and an output interface 160. The processor 130, which may comprise a microprocessor, a micro-controller, an application specific integrated circuit (ASIC), and the like, is configured to perform various processing functions. One of the processing functions includes invoking or implementing the modules 104-116 of the category path determining apparatus 102 to determine at least one category path for identifying a selected input text.

According to an example, the category path determining apparatus 102 comprises a hardware device, such as, a circuit or multiple circuits arranged on a board. In this example, the modules 104-116 comprise circuit components or individual circuits. According to another example, the category path determining apparatus 102 comprises software stored, for instance, in a volatile or non-volatile memory, such as dynamic random access memory (DRAM), electrically erasable programmable read-only memory (EEPROM), magnetoresistive random access memory (MRAM), flash memory, floppy disk, a compact disc read only memory (CD-ROM), a digital video disc read only memory (DVD-ROM), or other optical or magnetic media, and the like. In this example, the modules 104-116 comprise software modules stored in the memory. According to a further example, the category path determining apparatus 102 comprises a combination of hardware and software modules.

The category path determining apparatus 102 may comprise a plug-in to a messaging application, which comprises any reasonably suitable application that enables communication over a network, such as, an intranet, the Internet, etc., through the system 100, for instance, an e-mail application, a chat messaging application, a text messaging application, etc. In addition, or alternatively, the category path determining apparatus 102 may comprise a plug-in to a browser application, such as, a web browser, which allows access to webpages over an extranet, such as, the Internet or a file browser, which enables the user to browse through files stored locally on the user's system 100 or through files stored externally, for instance, on a shared server. As a yet further example, the category path determining apparatus 102 may comprise a standalone apparatus configured to interact with a messaging application, a browser application, or another type of application.

As shown in FIG. 1, the category path determining apparatus 102 includes a pre-processing module 104, a category determining module 106, a concept determining module 108, a category path determining module 110, a category path relevance determining module 112, a category path generating module 114, and an output module 116. It should be understood that the category path determining apparatus 102 may comprise additional modules and that one or more of the modules 104-116 may be removed and/or modified without departing from a scope of the category path determining apparatus 102. For instance, one or more of the functions described with respect to particular ones of the modules 104-116 may be combined into one or more of another module 104-116.

The category path determining apparatus 102 is configured to receive as input, input text from a document, which may comprise a scanned document, a webpage, a magazine article, an email message, a text message, a newspaper article, a handwritten note, an entry in a database, etc., and to automatically determining a category path that identifies the input text through use of machine-readable labels. A user may interact with the category path determining apparatus 102 through the input source 140, which may comprise an interface device, such as, a keyboard, mouse, or other input device, to input the input text into the category path determining apparatus 102. A user may also use the input source 140 to instruct the category path determining apparatus 102 to generate the at least one category path to identify a desired input text, which may include an entire document, to which the category path determining apparatus 102 has access. In addition, a user may also use the input source 140 to navigate through one or more category paths determined for the input text.

The category path determining apparatus 102 is configured to access and employ a labeled text data source in determining suitable categories and concepts for the input text and in determining the one or more category paths through a hierarchy of categories. The labeled text data source generally comprises a third-party database of articles, such as, Wikipedia™, Freebase™, IMDB™, and the like. The articles contained in the labeled text data sources are often assigned to one or more categories and sub-categories associated with the particular labeled text data sources. For instance, in the Wikipedia™ database, each of the articles is assigned a particular concept and in addition the concepts are assigned to particular categories and sub-categories defined by the editors of the Wikipedia™ database. As discussed in greater detail herein below, the concepts and categories used in a labeled text data source, such as the Wikipedia™ database, are leveraged in determining the one or more category paths for identifying an input text.

According to an embodiment, some or all of the predefined category hierarchy may be manually defined. The category levels that are not manually defined may be computed from categorical information contained in the labeled text data source. Thus, for instance, a user may define a root node and one or more child nodes and may rely on the category levels contained in the labeled text data source for the remaining child nodes in the hierarchy of predefined category levels. According to a particular embodiment, a user may define the hierarchy of predefined category levels as a tree structure and may map the categories of the labeled text data source into the tree structure. According to another embodiment, the pre-processing module 104 may be configured to automatically map concepts from the labeled text data source into the hierarchy of predefined category levels. According to an additional embodiment, the relevance of each concept to each category may be recorded as the probability that another article that mentions that concept would appear in that category. According to yet another embodiment, categories may further be labeled as being useful for disambiguating concepts (see below) or as useful for display to an end user.

The category path determining apparatus 102 may output at least one category path to determine the input text through the output interface 160. The output interface 160 may provide an interface between the category path determining apparatus 102 and another component of the system 100, such as, the data store 150, upon which at least one determined category path may be stored. In addition, or alternatively, the output interface 160 may provide an interface between the category path determining apparatus 102 and an external device, such as a display, a network connection, etc., such that the at least one category path may be communicated externally to the category path determining apparatus 102.

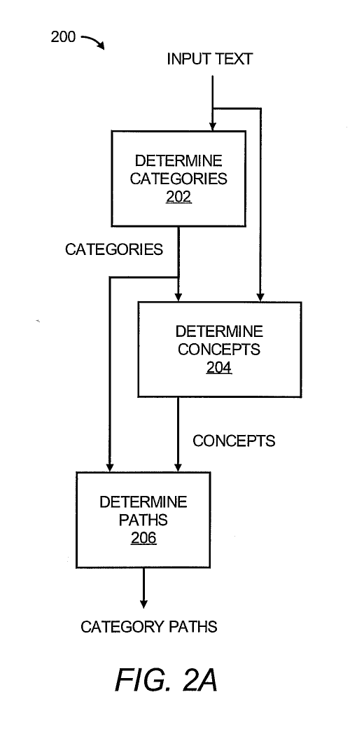

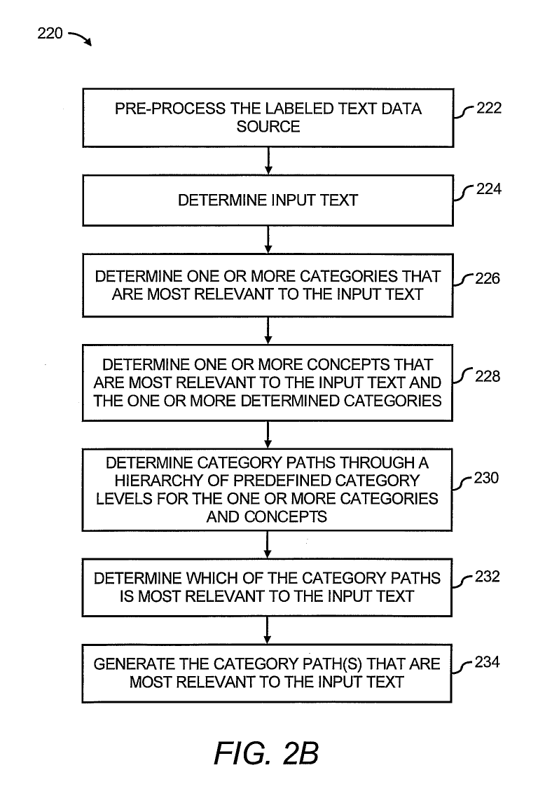

Various manners in which the modules 104-116 of the category path determining apparatus 102 may operate in determining the category path of an input text to enable the input text to be identified by a computing device is discussed with respect to the methods 200 and 220 depicted in FIGS. 2A and 2B. It should be apparent to those of ordinary skill in the art that the methods 200 and 220 respectively depicted in FIGS. 2A and 2B represent generalized illustrations and that other steps may be added or existing steps may be removed, modified or rearranged without departing from the scopes of the methods 200 and 220. Although particular reference is made to the system 100 depicted in FIG. 1 as performing the steps outlined in the methods 200 and 220, it should be understood that the methods 200 and 220 may be performed by a differently configured system 100 without departing from a scope of the methods 200 and 220.

With reference first to FIG. 2A, there is shown a flow diagram of a method 200 of determining at least one category path for identifying an input text, in which the at least one category path runs through a hierarchy of predefined category levels, according to an example. At step 202, one or more categories that are most relevant to input text are determined. In addition, at step 204, one or more concepts are determined from a labeled text data source that are most relevant to the input text using information from the labeled text data source and the one or more categories determined at step 202. Moreover, at step 206, category paths through a hierarchy of predefined category levels are determined for one or more categories determined at step 202 which terminate at one or more concepts for the input text determined at step 208.

With reference now to FIG. 2B, there is shown a flow diagram of a method 220, which is similar and includes additional detail to the method 200 depicted in FIG. 2A. At step 222, the labeled text data source is pre-processed, for instance, by the pre-processing module 104. By way of a particular example, the pre-processing module 104 is configured to analyze the labeled text data source corpus, finding categories for each concept by mapping the labeled text data source categories into a category graph (such as, a manually constructed category tree), finding phrases related to each category by using the text of articles assigned to concepts in each category, finding phrases related to each concept by using the text anchor tags which point to that concept, and evaluating counts of occurrences to determine the probability that an occurrence of a particular phrase indicates the text is relevant to a particular category or a particular concept. For example if 10% of articles containing the text “Tiger” are in the category “Golf”, then the probability of the input text being in the category “Golf”, given that it contains the text “Tiger”, is 0.1. As another example, if 30% of the occurrences of the text “Tiger” link to the article labeled with the concept “Tiger Woods”, then the probability that the input text is related to “Tiger Woods”, given that we've observed it contains the text “Tiger”, is 0.3. In this way, the pre-processing module 104 creates dictionaries of probabilities that map concepts to categories, map anchor tags to categories, and map anchor tags to concepts. As discussed below, these dictionaries are used by the category determining module 106, the concept determining module 108, and the category path determining module 110.

At step 224, an input text is determined, for instance, by the category path determining apparatus 102. The category path determining apparatus 102 may determine the input text, for instance, through receipt of instructions from a user to initiate the method 220 on specified input text, which may include part of or an entire document. The category path determining apparatus 102 may also automatically determine the input text, for instance, as part of an algorithm configured to be executed as a user is browsing through one or more documents, or as part of an algorithm to send or receive textual content.

At step 226, one or more categories are determined from the category hierarchy that are most relevant to the input text, for instance, by the category determining module 106. The category determining module 106 may compare the input text with the text contained in a plurality of articles in the labeled text data source to determine which of the plurality of categories is most relevant to the input text. According to a particular example, category determining module 106 is configured to make this determination by looking up phrases from the input text in the dictionaries constructed by the pre-processing module 104 and then computing a probability for each category using the probabilities for each category given the presence of each matching phrase.

According to another embodiment, the category determining module 106 may also make use of additional information either from the input source 140 or known about the user, or known about a group to which the user is known to belong, or known about users who are known to be similar to the user, etc. For example, a page with the url “http://somenewspaper.com/2009/10/sports/783328.html” may be known to be in the category “Sports”, while a url “http://nba.com” may be known to be in both the higher-level category “Sports” and the lower-level category “Basketball”. As another example, if the user is known to visit a relatively large number of Baseball-related pages, then the category determining module 106 may be configured to give higher weight to the categories “Sports” and “Basketball”. As a further example, if the user is a member of a group, and many other members of that group have identified themselves as fans of Tiger Woods, then the category determining module 106 may also give higher weight to the categories “Sports” and “Golf”.

At step 228, one or more concepts are determined from the labeled text data source that are most relevant to the input text using information from the labeled data source and the categories determined at step 226, for instance, by the concept determining module 108. The concept determining module 108 may compare the input text with the text contained in a plurality of articles in the labeled text data source to determine which of the plurality of concepts may plausibly be relevant to the input text. According to a particular example, the concept determining module 108 makes this determination by searching for phrases from the input text in the dictionaries constructed by the pre-processing module 104 and then computing a probability for each concept using the probabilities for each concept given the presence of each matching phrase and the category probabilities computed at step 226. For example, if the input text includes the term “Giants” then there are several plausible concepts, however, if the input text is likely to be in the category “baseball”, then the concept determining module 108 is configured to determine that articles pertaining to the San Francisco Giants baseball team are more relevant to the input text than articles pertaining to the New York Giants football team. In an embodiment, a probability is computed for each plausible concept.

According to another embodiment, the concept determining module 108 may also make use of additional information either from the input source 140 or known about the user, or known about a group to which the user is known to belong, or known about users who are known to be similar to the user, etc., as discussed above with respect to the category determining module 106.

At step 230 category paths through the hierarchy of predefined category levels for the one or more plausible categories are determined for the input text determined at step 226 which terminate at any of the plausible concepts for the input text determined at step 228, for instance, by the category path determining module 112. By way of particular example in which a plausible concept is “Hillary Rodham Clinton”, and plausible categories are “American Politicians” and “Obama Administration”, then examples of two plausible category paths are: “/People/Politicians/American Politicians/Hillary Rodham Clinton” and “/Society/Politics/Government/Government in the United States/United States Presidential administrations/Obama Administration/Obama Administration personnel/Hillary Rodham Clinton”.

At step 232, a determination as to which of the plausible category paths are most relevant to the input text is made, for instance by the category path relevance determining module 114. According to an embodiment, the category path relevance determining module 114 computes metrics for each of the plurality of plausible category paths, in which the metrics are designed to identify a relevance level for each of the category paths with respect to the input text. For instance, the category path relevance determining module 114 weights each of the categories in the plausible category paths based upon the relevance of each of those categories to the input text. In one embodiment, relevance is measured by using the probabilities computed for each category by the category determining module 106, the probabilities for each concept computed by the concept determining module 108, and the prior probabilities computed by the pre-processing module 104.

In order to provide a clearer understanding of step 232, a particularly simple example is provided in which plausible paths are compared by simply summing the scores of their component parts. In this example, one of the category paths is “/Culture/Sports/Tiger Woods”, a second category path is “/Culture/Sports/Golf/Tiger Woods”, and a third category path is “/People/Philanthropists/Tiger Woods”. If “Sports” is assigned a score of 0.2 and “Golf” is assigned a score of 0.2, and all other categories have a score of 0, then the first path, “/Culture/Sports/Tiger Woods”, has a total score of 0.2, the second path, “/Culture/Sports/Golf/Tiger Woods”, a total score of 0.4 and the third path a score of 0. Thus, in this example, the category path relevance determining module 114 may determine that the second category path is the most relevant to the input text.

In another example, the category path relevance determining module 114 is configured to employ a more sophisticated metric which uses properties of the input text as well as the categories of the labeled text data source and considers the similarity of the input text to the other pages in each category along the category paths. According to a further example, the category path relevance determining module 114 is configured to pre-compute standard information retrieval metrics on the labeled text data source, such as “PageRank”, and to use those metrics as inputs to the path weight.

According to another embodiment, the category path relevance determining module 114 is configured to further control which of the category paths are determined to be the most relevant to the input text based upon other factors. For instance, the category path relevance determining module 114 may consider the amount of processing time required to go through each of the category paths as a factor in determining which of the one or more category paths are selected as being the most relevant to the input text. Thus, for instance, a user may instruct the category path relevance determining module 114 when the additional processing and storage required for longer category paths are acceptable and when they are not. As another example, the length of the suitable category paths selected by the category path relevance determining module 114 determined to be the most relevant to the input text may be dependent upon the application employing the category path determining apparatus 102. As a further example, the category path relevance determining module 112 may also make use of additional information from the input source 140 or known about the user, or known about a group to which the user is known to belong, or known about users who are known to be similar to the user, as discussed above with respect to the category determining module 106.

At step 234, at least one category path for the one or more concepts determined to be the most relevant to the input text is generated, for instance, by the category path generating module 114. According to an example, the category path generating module 114 may generate a plurality of category paths through different categories to define the input text. In addition, the category path determining apparatus 102 may output the at least one category path determined for the input text through the output interface 160, as discussed above.

Some or all of the operations set forth in the methods 200 and 220 may be contained as one or more utilities, programs, or subprograms, in any desired computer accessible medium. In addition, some or all of the operations set forth in the methods 200 and 220 may be embodied by computer programs, which may exist in a variety of forms both active and inactive. For example, they may exist as software program(s) comprised of program instructions in source code, object code, executable code or other formats. Any of the above may be embodied on a computer readable medium.

Exemplary computer readable storage medium include conventional computer system random access memory (RAM), read-only memory (ROM), erasable programmable read-only memory (EPROM), EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

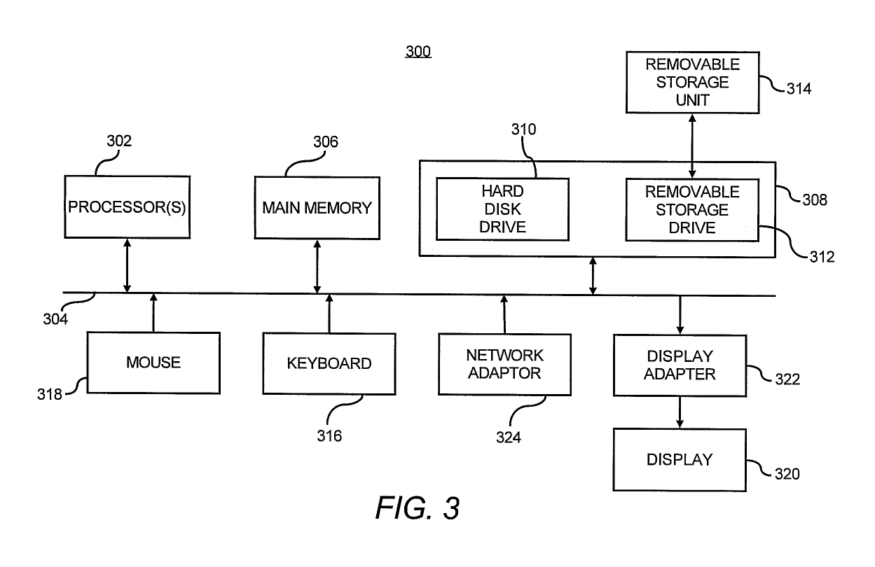

FIG. 3 illustrates a block diagram of a computing apparatus 300, such as the system 100 depicted in FIG. 1, according to an example. In this respect, the computing apparatus 300 may be used as a platform for executing one or more of the functions, such as the methods 200 and 220, described hereinabove with respect to the system 100.

The computing apparatus 300 includes one or more processors 302. The processor(s) 302 may be used to execute some or all of the steps described in the methods 200 and 220. Commands and data from the processor(s) 302 are communicated over a communication bus 304. The computing apparatus 300 also includes a main memory 306, such as a random access memory (RAM), where the program code for the processor(s) 302, may be executed during runtime, and a secondary memory 308. The secondary memory 308 includes, for example, one or more hard disk drives 310 and/or a removable storage drive 312, representing a floppy diskette drive, a magnetic tape drive, a compact disk drive, etc., where a copy of the program code for the methods 200 and 220 may be stored.

The removable storage drive 310 reads from and/or writes to a removable storage unit 314 in a well-known manner. User input and output devices may include a keyboard 316, a mouse 318, and a display 320. A display adaptor 322 may interface with the communication bus 304 and the display 320 and may receive display data from the processor(s) 302 and convert the display data into display commands for the display 320. In addition, the processor(s) 302 may communicate over a network, for instance, the Internet, a local area network (LAN), etc., through a network adaptor 324.

It will be apparent to one of ordinary skill in the art that other known electronic components may be added or substituted in the computing apparatus 300. It should also be apparent that one or more of the components depicted in FIG. 3 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method of determining at least one category path for identifying an input text, said method comprising:
in a computing device, determining one or more categories that are most relevant to the input text;
determining one or more concepts that are most relevant to the input text using information from a labeled text data source and the one or more categories determined to be the most relevant to the input text; and
determining one or more category paths through a hierarchy of predefined category levels for one or more of the determined concepts.

2. The method according to claim 1, wherein the labeled text data source includes a corpus having a plurality of concepts and categories, said method further comprising:
pre-processing the labeled text data source to find categories for each of the concepts by mapping the categories into a category graph, to find phrases related to each category by using text of articles assigned to the concepts in each category, to find phrases related to each concept by using text anchor tags which point to that concept, and to evaluate counts of occurrences to determine the probability that an occurrence of a particular phrase indicates the text is relevant to a particular category or a particular concept.

3. The method according to claim 2, wherein pre-processing the labeled text data source further comprises creating dictionaries of probabilities that map the concepts to the categories, that map the anchor tags to the categories, and that map the anchor tags to the concepts

4. The method according to claim 3, wherein the labeled text data source comprises a plurality of articles and wherein determining the one or more categories that are most relevant to the input text further comprises comparing the input text with text contained in the plurality of articles by looking up phrases from the input text in the dictionaries and by computing a probability for each of the one or more categories using probabilities for each category based upon whether the phrases from the input text match phrases in the dictionaries.

5. The method according to claim 4, wherein determining at least one of to the one or more categories, the one or more concepts, and the one or more category paths further comprises using information of at least one of a user, a group to which the user belongs, and known about users who are known to be similar to the user.

6. The method according to claim 4, wherein determining the one or more concepts that are most relevant to the input text further comprises comparing the input text with text contained in the plurality of articles to determine which of the concepts is plausibly relevant to the input text by:
searching for phrases from the input text in the dictionaries; and
computing a probability for each concept using the probabilities for each concept based upon whether the phrases from the input text match phrases in the dictionaries and the category probabilities.

7. The method according to claim 6, further comprising:
determining which of the one or more concepts are plausibly relevant to the input text;
determining which of the one or more plausibly relevant concepts are the most relevant to the input text; and
wherein determining the one or more category paths further comprises determining which of the one or more category paths are plausibly relevant to the input text from the determined one or more plausibly relevant concepts.

8. The method according to claim 7, further comprising:
computing metrics for each of the one or more plausibly relevant category paths, wherein the metrics are designed to identify a relevance level for each of the plausibly relevant category paths with respect to the input text, to identify which of the one or more plausibly relevant category paths are the most relevant to the input text.

9. The method according to claim 7, further comprising:
generating at least one category path to identify the input text, wherein the at to least one category path terminates at the one or more plausibly relevant concepts determined to be the most relevant to the input text.

10. An apparatus for determining at least one category path for identifying an input text, said apparatus comprising:
a category determining module configured to determine one or more categories that are most relevant to the input text;
a concept determining module configured to determine one or more concepts that are most relevant to the input text using information from a labeled text data source and the one or more categories determined to be the most relevant to the input text;
a category path determining module configured to determine one or more category paths through a hierarchy of predefined category levels for one or more determined concepts; and
a category path relevance determining module configured to determine which of the one or more category paths is most relevant to the input text.

11. The apparatus according to claim 10, wherein the labeled text data source includes a corpus having a plurality of concepts and categories, said apparatus further comprising:
a pre-processing module configured to pre-process the labeled text data source to find categories for each of the concepts by mapping the categories into a category graph, to find phrases related to each category by using text of articles assigned to the concepts in each category, to find phrases related to each concept by using text anchor tags which point to that concept, and to evaluate counts of occurrences to determine the probability that an occurrence of a particular phrase indicates the text is relevant to a particular category or a particular concept.

12. The apparatus according to claim 11, wherein the pre-processing module is further configured to create dictionaries of probabilities that map the concepts to the categories, that map the anchor tags to the categories, and that map the anchor tags to the concepts.

13. The apparatus according to claim 12, wherein the labeled text data source comprises a plurality of articles and wherein the category determining module is further configured to compare the input text with text contained in the plurality of articles by looking up phrases from the input text in the dictionaries and by computing a probability for each of the one or more categories using probabilities for each category based upon whether the phrases from the input text match phrases in the dictionaries.

14. The apparatus according to claim 13, wherein at least one of the category determining module, the concept determining module, and the category path determining module is further configured to use information of at least one of a user, a group to which the user belongs, and known about users who are known to be similar to the user.

15. The apparatus according to claim 13, wherein the concept determining module is further configured to search for phrases from the input text in the dictionaries and to compute a probability for each concept using the probabilities for each concept based upon whether the phrases from the input text match phrases in the dictionaries and the category probabilities to determine which of the concepts is plausibly relevant to the input text.

16. The apparatus according to claim 15, wherein the concept determining module is further configured to determine which of the one or more concepts are plausibly relevant to the input text and which of the one or more plausibly relevant concepts are the most relevant to the input text, said apparatus further comprising:
a category path relevance determining module configured to identify which of the one or more category paths are plausibly relevant to the input text from the determined one or more plausibly relevant concepts.

17. The apparatus according to claim 16, wherein the category path relevance determining module is further configured to compute metrics for each of the one or more plausibly relevant category paths, wherein the metrics are designed to identify a relevance level for each of the plausibly relevant category paths with respect to the input text, to identify which of the one or more plausibly relevant category paths are the most relevant to the input text.

18. The apparatus according to claim 16, further comprising:
a category path generating module configured to generate at least one category path to identify the input text, wherein the at least one category path terminates at the one or more plausibly relevant concepts determined to be the most relevant to the input text.

19. A computer readable storage medium on which is embedded one or more computer programs, said one or more computer programs implementing a method of determining at least one category path for identifying an input text, said one or more computer programs comprising a set of instructions for:
determining one or more categories that are most relevant to the input text;
determining one or more concepts that are most relevant to the input text using information from a labeled text data source and the one or more categories determining to be the most relevant to the input text; and
determining one or more category paths through a hierarchy of predefined category levels for one or more of the determined concepts.

20. The computer readable storage medium according to claim 19, said one or more computer programs comprising a set of instructions for:
pre-processing the labeled text data source to find categories for each of the concepts by mapping the categories into a category graph, to find phrases related to each category by using text of articles assigned to the concepts in each category, to find phrases related to each concept by using text anchor tags which point to that concept, and to evaluate counts of occurrences to determine the probability that an occurrence of a particular phrase indicates the text is relevant to a particular category or a particular concept.
